(19) United States
(12) Patent Application Publication
(10) Pub. No.: US 2009/0002057 A1
(43) Pub. Date: Jan. 1, 2009

(54) Temperature sensor circuit and method for controlling the same

(75) Inventor: Mi Hyun Hwang, Anyang-si (KR)

Correspondence Address: COOPER & DUNHAM, LLP, 1185 AVENUE OF THE AMERICAS, NEW YORK, NY, 10036, US

(73) Assignee: Hynix Semiconductor Inc.

(21) Appl. No.: 12/001,666

(22) Filed: Dec. 12, 2007

(30) Foreign Application Priority Data
Jun. 27, 2007 (KR) 10-2007-0063933

(51) Int. Cl. G01K 7/01

(52) U.S. Cl. 327/512

(57) ABSTRACT

A temperature sensor circuit includes a first reference voltage generator configured to generate a first reference voltage signal by using a first signal linearly varying with temperature, a second reference voltage generator configured to generate a second reference voltage signal with a predetermined logic level by using the first reference voltage signal, and a controller configured to compare the first signal with the second reference voltage signal and control a voltage level of the first signal according to the comparison result.

### BACKGROUND

The present disclosure relates to a semiconductor device, and more particularly, to a temperature sensor circuit for measuring internal temperature to output digital code or changing a self-refresh period according to the measured internal temperature.

Generally, a temperature sensor circuit utilizes a bandgap reference voltage generator. The bandgap reference voltage generator stably supplies a constant voltage in spite of the variation of temperature or external voltage. The bandgap reference voltage is widely used in a variety of applications requiring a reference voltage, for example, semiconductor memory devices or on-die thermal sensors.

The bandgap reference voltage generator includes a base-emitter voltage (V_{BE}) generating unit and a thermal voltage (V_{T}) generating unit. The base-emitter voltage generating unit is implemented with a diode-connected bipolar transistor and supplies a constant diode voltage. The thermal voltage (V_{T}) generating unit generates a voltage proportional to KT (where K is Boltzmann's constant and T is absolute temperature) using the difference of base-emitter voltages (V_{BE}) of two bipolar transistors. The bandgap reference voltage generator minimizes a temperature coefficient by generating a reference voltage (V_{REF}) signal, where V_{REF}=V_{BE}+KV_{T}.

The bandgap reference voltage generator is named in the sense that the reference voltage is substantially equal to a bandgap voltage of silicon (Si).

FIG. 1 illustrates a circuit diagram of a conventional temperature sensor circuit, FIG. 2 illustrates a graph of an error rate according to the change of temperature in the conventional temperature sensor circuit of FIG. 1, and FIG. 3 illustrates a graph of a base-emitter voltage signal with respect to temperature in the conventional temperature sensor of FIG. 1.

Referring to FIG. 1, the conventional temperature sensor circuit includes a first reference voltage generator 100 and a second reference voltage generator 200. The first reference voltage generator 100 generates a first reference voltage signal VREF by using a base-emitter voltage signal VTEMP that linearly varies with temperature. The second reference voltage generator 200 generates second reference voltage signals VULIMIT and VLLIMIT having predetermined logic levels by using the first reference voltage signal VREF.

The voltage signal VTEMP inversely proportional to temperature is used for temperature sensing. The second reference voltage signals VULIMIT and VLLIMIT are used as a biasing voltage of an analog-to-digital converter (ADC). The ADC converts the analog voltage signal VTEMP into a digital code.

In order for accurate temperature measurement, the input range of the ADC is defined by the reference voltages of the bandgap reference voltage generator. An upper limit of the input voltage is defined as VULIMIT and a lower limit of the input voltage is defined as VLLIMIT. The ADC compares a DAC voltage with the voltage signal VTEMP to determine a digital code. Temperature information is determined according to the digital code. At this point, errors such as Process-Voltage-Temperature (PVT) variation or comparator offset may occur during this procedure.

To reduce these errors, a trimming process is performed at a high temperature. After setting an external temperature to approximately 90° C., the trimming process is performed to make the reference voltage signal VLLIMIT have the same voltage level as the voltage signal VTEMP. After the trimming process, an error rate decreases at a high temperature, e.g., approximately 90° C.

On the other hand, the error rate increases as temperature decreases. The error rate at a low temperature can be reduced by performing the trimming process once again. However, this involves increasing test time.

### BRIEF SUMMARY

In an aspect of the present disclosure, a temperature sensor circuit includes a first reference voltage generator configured to generate a first reference voltage signal by using a first signal linearly varying with temperature, a second reference voltage generator configured to generate a second reference voltage signal, with a predetermined logic level by using the first reference voltage signal, and a controller configured to compare the first signal with the second reference voltage signal and control a voltage level of the first signal according to the comparison result.

The first signal may be a base-emitter voltage signal with a negative temperature coefficient.

The controller may be configured to clamp the first signal to a voltage level of the second reference voltage signal when the first signal is higher than the second reference voltage signal.

In another aspect of the disclosure, a method for controlling a temperature sensor circuit includes generating a first reference voltage signal by using a first signal that linearly varies with temperature, generating a second reference voltage signal with a predetermined logic level by using the first reference voltage signal, and comparing the first signal with the second reference voltage signal and controlling a voltage level of the first signal according to the comparison result.

### BRIEF DESCRIPTION OF THE DRAWINGS

The above and other features of the subject matter of the present disclosure will be more apparent from the following detailed description taken in conjunction with the accompanying drawings, in which:

FIG. 1 illustrates a circuit diagram of a conventional temperature sensor circuit;

FIG. 2 illustrates a graph of an error rate according to the change of temperature in the conventional temperature sensor circuit of FIG. 1;

FIG. 3 illustrates a graph of a base-emitter voltage signal with respect to temperature in the conventional temperature sensor of FIG. 1;

FIG. 4 illustrates a circuit diagram of a temperature sensor circuit according to an exemplary embodiment of the present invention;

FIG. 5 illustrates a graph of a base-emitter voltage signal with respect to temperature in the temperature sensor circuit of FIG. 4; and

FIG. 6 illustrates a graph of an error rate according to the change of temperature in the temperature sensor circuit of FIG. 4.

### DESCRIPTION OF EXEMPLARY EMBODIMENTS

Hereinafter, a temperature sensor circuit and a method for controlling the same in accordance with examples and exemplary embodiments of the present invention will be described in detail with reference to the accompanying drawings.

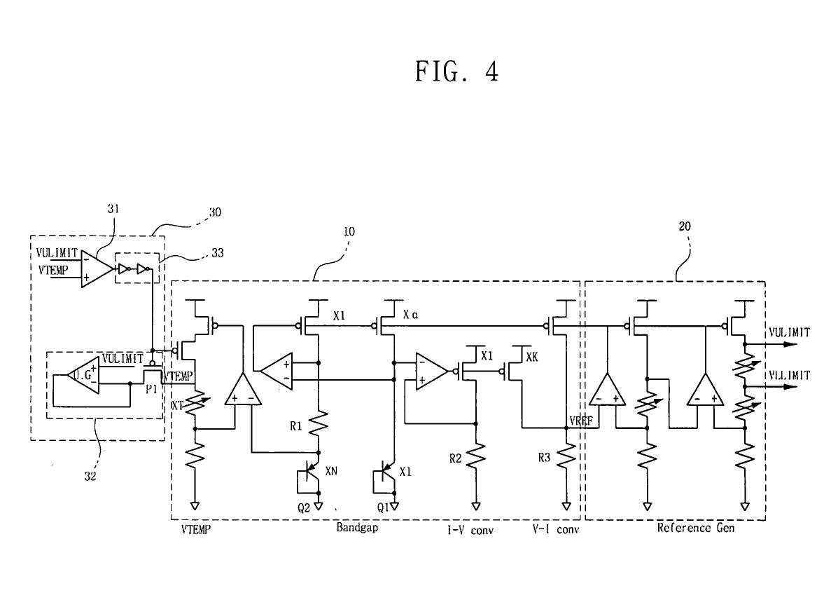

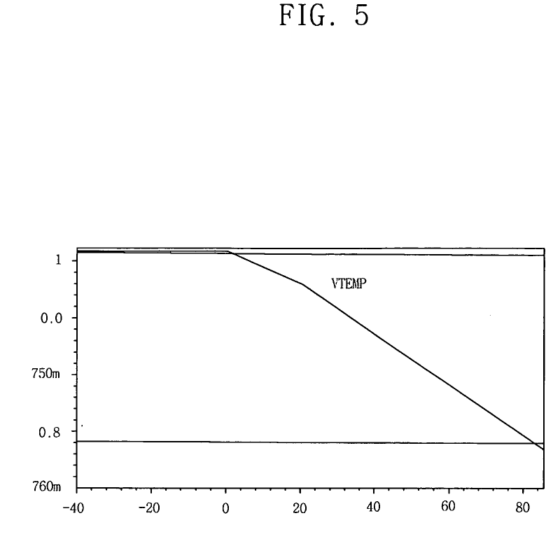

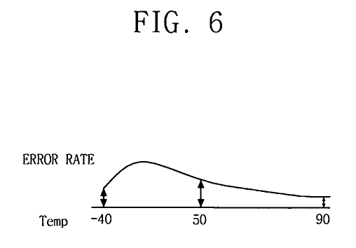

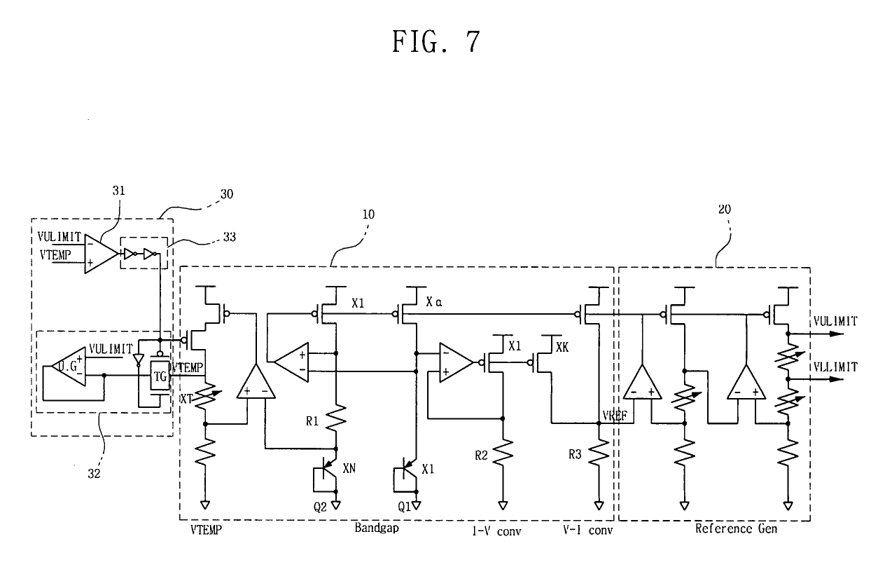

FIG. 4 illustrates a circuit diagram of a temperature sensor circuit according to an exemplary embodiment of the present invention, FIG. 5 illustrates a graph of a base-emitter voltage signal with respect to temperature in the temperature sensor circuit of FIG. 4, and FIG. 6 illustrates a graph of an error rate according to the change of temperature in the temperature sensor circuit of FIG. 4.

Referring to FIG. 4, the temperature sensor circuit includes a first reference voltage generator 10, a second reference voltage generator 20, and a controller 30. The first reference voltage generator 10 generates a first reference voltage signal VREF by using a voltage signal VTEMP that linearly varies with temperature. The second reference voltage generator 20 generates second reference signals VULIMIT and VLLMIT with predetermined logic levels by using the first reference signal VREF. The controller 30 compares the voltage signal VTEMP with the second reference voltage VULIMIT.

The voltage signal VTEMP is a base-emitter voltage signal with a negative temperature coefficient. That is, the voltage signal VTEMP is a base-emitter voltage signal that is inversely proportional to temperature.

The controller 30 clamps the voltage signal VTEMP to a voltage level of the second reference voltage signal VULIMIT when the voltage signal VTEMP is higher than the second reference voltage signal VULIMIT.

The controller 30 includes a comparator 31, a buffer 33, and a clamper 32. The comparator 31 compares the voltage signal VTEMP with the second reference voltage signal VULIMIT. The buffer 33 buffer an output signal of the comparator 31. The clamper 32 clamps the voltage signal VTEMP to the voltage level of the second reference voltage signal VULIMIT.

The clamper 32 includes a unit gain buffer UG and a driver P1. The unit gain buffer UG is configured to buffer an input signal in response to the second reference voltage signal VULIMIT, and the driver P1 is configured to receive an output signal of the unit gain buffer UG to output the voltage signal VTEMP in response to an output signal of the comparator 31.

As illustrated in FIG. 4, the clamper 32 may include a unit gain buffer and a transmission gate. The unit gain buffer is configured to buffer in response to the second reference voltage signal VULIMIT, and the transmission gate is configured to transmit the output signal of the unit gain buffer as the voltage signal VTEMP in response to the output signal of the comparator 31.

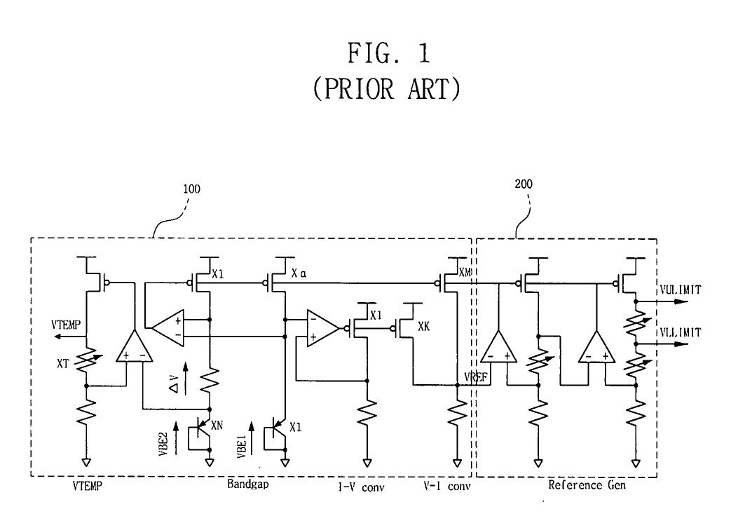

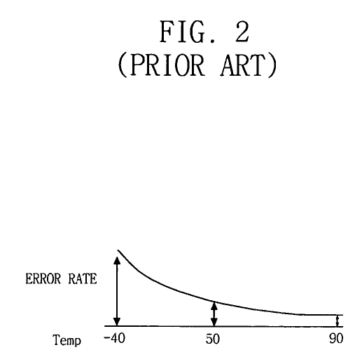

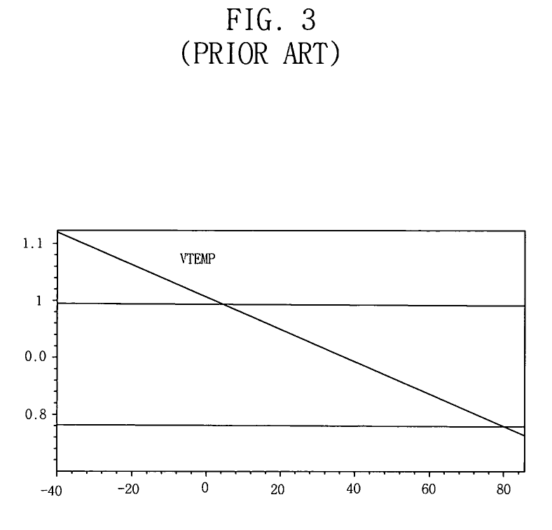

The first reference voltage generator 10 generates a reference voltage (V_{REF}) signal, where V_{REF}=V_{BE}+KV_{T}. More specifically, the first reference voltage generator 10 includes a base-emitter voltage (V_{BE}) generating unit and a thermal voltage (V_{T}) generating unit. The base-emitter voltage (V_{BE}) generating unit is implemented with a diode-connected bipolar transistor and supplies a constant diode voltage. The thermal voltage (V_{T}) generating unit generates a voltage proportional to KT (where K is Boltzmann's constant and T is absolute temperature) using the difference of base-emitter voltages (V_{BE}) of two bipolar transistors. The second reference voltage generator 20 generates the second reference voltage signals VULIMIT and VLLIMIT by using the first reference voltage signal VREF. Since the structures of the first and second reference voltage generators 10 and 20 are similar to those of FIG. 1, their detailed description will be omitted for conciseness.

An operation of the temperature sensor circuit according to the exemplary embodiment of FIG. 4 will be described below.

The temperature sensor circuit according to the exemplary embodiment of the present invention shown in FIG. 4 can reduce a trimming error by additionally controlling the voltage signal VTEMP.

First, the trimming process is performed at a high temperature to make the reference voltage signal VLLIMIT have the same voltage level as the voltage signal VTEMP. However, an error increases at a low temperature because the reference voltage signal VULIMIT also changes by a trimmed rate of the reference voltage signal VLLIMIT. To correct the error, the voltage signal VTEMP depending on the changed reference voltage signal VLLIMIT is generated.

The comparator 31 compares the voltage signal VTEMP with the reference voltage signal VULIMIT and outputs a low signal when the voltage signal VTEMP is higher than the reference voltage signal VULIMIT. A feedback path of the voltage signal VTEMP is disconnected by the low signal and the voltage signal VTEMP is clamped to the reference voltage signal VULIMIT.

Consequently, the reference voltage signal VULIMIT serves as the upper limit of the voltage signal VTEMP that is inversely proportional to temperature. Since the additional circuit does not affect the reference voltage signal VLLIMIT, the trimmed signal is not distorted at a high temperature.

Instead of the reference voltage signal VULIMIT, the output signal of the unit gain buffer can be used as a clamping source. The reason for this is that if the reference voltage signal VULIMIT is directly used, the voltage level of the voltage signal VREF may be distorted because of influence on charges of the voltage signal VTEMP.

Consequently, the error rate that has increased as temperature decreases is reduced at below a predetermined temperature. A simulation result is illustrated in FIG. 5, and an error rate according to the change of temperature is illustrated in FIG. 6.

As described above, the temperature sensor circuit according to the exemplary embodiment of the present invention compares the voltage signal VTEMP inversely proportional to temperature with the reference voltage signal VULIMIT and controls the voltage level of the voltage signal VTEMP according to the comparison result, thereby reducing the error rate even at a low temperature.

While the present invention has been described with respect to examples and exemplary embodiments, it will be apparent to those skilled in the art that various changes and modifications may be made without departing from the spirit and scope of the present disclosure and the following claims.

The present application claims priority to Korean patent application number 10-2007-63933, filed on Jun. 27, 2007, the entire contents which are incorporated herein by reference.

What is claimed is:

1. A temperature sensor circuit, comprising:
a first reference voltage generator configured to generate a first reference voltage signal by using a first signal linearly varying with temperature;
a second reference voltage generator configured to generate a second reference voltage signal with a predetermined logic level by using the first reference voltage signal; and
a controller configured to compare the first signal with the second reference voltage signal and control a voltage level of the first signal according to a comparison result.

2. The temperature sensor circuit of claim 1, wherein the first signal is a base-emitter voltage signal with a negative temperature coefficient.

3. The temperature sensor circuit of claim 1, wherein the controller is configured to clamp the first signal to a voltage level of the second reference voltage signal when the first signal is higher than the second reference voltage signal.

4. The temperature sensor circuit of claim 1, wherein the controller comprises:
a comparator configured to compare the first signal with the second reference voltage signal; and
a clamper configured to clamp the first signal to a voltage level of the second reference voltage signal in response to an output signal of the comparator.

5. The temperature sensor circuit of claim 4, wherein the controller further comprises a buffer configured to buffer an output signal of the comparator.

6. The temperature sensor circuit of claim 4, wherein the clamper comprises:
a unit gain buffer configured to buffer an input signal in response to the second reference voltage signal; and
a driver configured to output an output signal of the unit gain buffer as the first signal in response to the output signal of the comparator.

7. The temperature sensor circuit of claim 4, wherein the clamper comprises:
a unit gain buffer configured to buffer an input signal in response to the second reference voltage signal; and
a transmission gate configured to transmit an output signal of the unit gain buffer in response to the output signal of the comparator.

8. A method for controlling a temperature sensor circuit, comprising:
generating a first reference voltage signal by using a first signal that linearly varies with temperature;
generating a second reference voltage signal with a predetermined logic level by using the first reference voltage signal; and
comparing the first signal with the second reference voltage signal and controlling a voltage level of the first signal according to a comparison result.

9. The method of claim 8, wherein the first signal is a base-emitter voltage signal with a negative temperature coefficient.

10. The method of claim 8, wherein the controlling of the voltage level of the first signal comprises clamping the first signal to a voltage level of the second reference voltage signal when the first signal is higher than the second reference voltage signal.
